(19) United States
(12) Patent Application Publication
(10) Pub. No.: US 2024/0009694 A1
(43) Pub. Date: Jan. 11, 2024

(54) ATOMIZER FOR A COATING COMPOSITION

(71) Applicant: ESS Holding GmbH, Steyr (AT)

(72) Inventors: Alireza Eslamian, Steyr (AT); Martin Schifko, Steyr (AT)

(21) Appl. No.: 18/021,555

(22) PCT Filed: Aug. 16, 2021
(86) PCT No.: PCT/AT2021/060285

§ 371 Date: Feb. 16, 2023

(30) Foreign Application Priority Data
Aug. 17, 2020 (AT) A50690/2020

(51) Int. Cl. B05B 17/00; B05B 3/02

(52) U.S. Cl. CPC B05B 17/0646; B05B 3/02

(57) ABSTRACT

An atomizer (1) for a coating composition comprises a coating composition substrate, which is vibration-excited by an exciter (3). Workpieces are provided with a coating of uniform thickness in such a way that resources are saved, and the coating composition substrate is a membrane (2) driven by a rotary drive and supplied with acoustic waves by an exciter (3) to vibrate.

### FIELD OF THE INVENTION

The invention relates to an atomizer for a coating composition comprising a coating composition substrate which is vibration-excited by an exciter.

### DESCRIPTION OF THE PRIOR ART

An atomizer for a coating composition is known from U.S. Pat. No. 4,659,014. The atomizer has a probe head as a coating composition substrate, which has a plurality of orifice openings flow-connected to a coating composition supply line and distributed circumferentially on the probe head. The coating composition flows from the coating composition supply line through the orifice openings and is thereby distributed on the coating composition substrate. The coating composition substrate may be subjected to vibrations by an exciter, causing the coating composition distributed on the coating composition substrate to detach from the coating composition substrate as finely atomized coating composition particles. However, the atomizer known from U.S. Pat. No. 4,659,014 has the disadvantage that the coating composition is distributed unevenly on the coating composition substrate due to gravity, among other things, which, reinforced by the shape of the probe head, leads to uneven application of the coating composition on a workpiece to be coated.

In order to influence the atomization of the coating composition particles, high-speed rotary atomizers or atomizers with air nozzles are known from the prior art. In addition to the disadvantage that such devices also produce an inhomogeneous coating, especially in the case of thin-film coatings, because the coating composition particles are imparted an uneven flow profile by the rotation or the air nozzles, they also require additional energy and operating resources.

### SUMMARY OF THE INVENTION

The invention is thus based on the object of proposing an atomizer of the type described at the beginning, with which workpieces can be provided with a coating of uniform thickness in a resource-saving manner.

The invention solves the set object in that the coating composition substrate is a membrane driven by a rotary drive and supplied with acoustic waves by the exciter to vibrate. As a result of these measures, the coating composition is evenly distributed on the surface of the membrane by the centrifugal force generated when the membrane rotates. Since the centrifugal force is used only to distribute the coating composition and not to detach it, the rotational speed can be selected to be relatively low, thus enabling energy-saving operation. In order to achieve uniform distribution of the coating composition over the entire surface of the membrane, the application of the coating composition can preferably be carried out in the center of the membrane. Due to the uniform thickness of the coating composition distributed on the membrane, the energy required to detach and atomize the coating composition is approximately the same over the entire surface of the membrane. The required energy input is provided by an exciter whose generated acoustic waves cause the membrane to vibrate. The acoustic waves propagate preferably through the air between the exciter and the membrane, which is why an installation-free sound propagation channel can be provided between the exciter and the membrane. In this context, installation-free means that there are no installations in the sound propagation channel that negatively influence the propagation of the acoustic waves generated by the exciter. Since there is no need for a separate actuator, such as a push rod, between the exciter and the membrane, the membrane can be set in vibration in a particularly energy-saving manner and driven in rotation by a simple shaft. Although in principle different shapes can be provided for the membrane, there are design advantages if the membrane is circular. The material for the membrane can be gold, for example, or other flexible and corrosion-resistant materials. A sound source connected to an amplifier can serve as the exciter. Depending on the application, the frequencies generated in this way can be in the human hearing frequency range or in the ultrasonic range.

Particularly favorable design conditions result if the membrane is pierced by an orifice opening of a coating composition supply line which passes through a shaft connecting the membrane to the rotary drive. In this way, a single connection point, namely the shaft, can be provided between the membrane and the rest of the atomizer. Preferably, the orifice opening is located at the center of rotation of the membrane, allowing uniform distribution of the coating composition as a result of rotation of the membrane.

Flow simulations and light sheet microscopy images have shown that the coating composition particles detaching from the coating composition substrate generate turbulences in the area between the atomizer and a workpiece to be coated. These turbulences influence the flow direction of the subsequently detached coating composition particles, resulting in an irregular coating of the workpiece. Therefore, in order to avoid mutual interference between coating composition particles detached one after the other in time, it is proposed that the membrane closes off a suction channel with a suction membrane section pierced by suction openings. In this case, the suction channel can be flow-connected to a vacuum reservoir. If a vacuum is applied to the suction channel, the air with undesirable turbulence is drawn through the suction openings into the suction channel, resulting in rectification or dissolution of the turbulence. In this way, homogeneous flow conditions are established in the area above the membrane, enabling a uniformly thick coating of a workpiece. In order to suck in as few coating composition particles as possible, the suction can be pulsed. For this purpose, the suction channel can be connected to the vacuum reservoir via a switchable valve, for example via a MEMS (Micro-Electro-Mechanical System) valve, servo valve, or rotary valve. The energy generated by the vacuum is preferably below the kinetic energy of the coating composition particles detached from the membrane and thus accelerated, in order to largely prevent them from being sucked in. In the case of a round membrane, longitudinal slots extending tangentially to the round membrane have proved particularly suitable as suction openings. For uniform suction, several suction membrane sections can be provided, which are evenly distributed over the membrane.

In order to prevent the coating composition from entering the suction openings when the coating composition is distributed by the rotational movement of the membrane, a step can be provided between the suction membrane section and the rest of the membrane surface to retain the coating composition exiting the orifice opening. When the membrane is rotated, the coating composition exiting the orifice opening cannot pass through the level of the step, which is elevated relative to the rest of the membrane. It does not matter in this context whether the suction membrane section has the height level of the rest of the membrane or the step. If the part intended for the coating composition is arranged between two suction membrane sections and thus between two steps, the distribution of the coating composition is promoted by the capillary effect occurring between the two steps, so that even low rotational speeds of the membrane are sufficient for distribution of the coating composition over the membrane surface provided for this purpose.

In terms of a compact design, the shaft for the rotary drive and for the coating composition supply can extend through the suction channel and preferably be arranged concentrically in it.

To enable largely uniform sound propagation starting from the exciter to the membrane, it is proposed that the shaft extends concentrically through the exciter. The hollow shaft can be designed in such a way that it is not or hardly vibrated by the acoustic waves generated by the exciter, so that the sound propagates mainly in the suction and sound propagation channel through which the shaft passes and then vibrates the membrane.

In particular, fast-curing multicomponent coating compositions, such as two-component coatings, can lead to clogging of the supply line of the atomizer after mixing the coating composition and the hardener. To prevent this and thus to be able to apply fast-curing coating compositions precisely to a workpiece, it is proposed that the coating composition supply line is connected to at least two feed lines. Accordingly, the different components are not premixed in the coating composition supply line, but are mixed gradually in the coating composition supply line and/or on the membrane itself, which reduces the reaction time of the components to each other and thus the risk of premature curing. The vibration of the membrane further mixes the components until detachment of the coating composition from the membrane occurs. The degree of mixing can be influenced by adjusting the vibration frequency of the membrane.

In order to enable constant coating qualities over a long period of time, the membrane must be replaced when worn. In order to detect such wear at an early stage, a vibration sensor can be provided to detect the frequency and/or amplitude of the membrane. In this way, deviations between the vibrations specified by the exciter and the vibrations of the membrane can be determined and, if a critical threshold is exceeded, the replacement of the membrane can be initiated. Hall sensors can be used for this purpose, for example. The vibration sensor can be arranged, for example, on membrane blades that project above the membrane in the direction of detachment of the coating composition.

In principle, the membrane can have a radial cross-section of constant thickness. In order to improve the mechanical stability of the membrane without hindering the vibrations in the outer detachment area of the membrane, it is proposed that the thickness of the membrane decreases radially outwards. For example, the radial cross-section of the membrane may have a conical basic shape.

In order for the atomizer to be able to coat large areas uniformly without being restricted by material-related dimensional limits, a coating head with several atomizers can be provided, with the atomizers being arranged next to one another in a matrix, and with the membranes lying in a common substrate plane. In this way, the atomizers themselves can be uniformly designed and manufactured, and the coating head can be adapted to the requirements of the workpiece to be coated as needed. In order to achieve uniform coating conditions over the entire coating head, the membranes lie in a common substrate plane.

To ensure that the atomizers arranged in the coating head do not influence each other in a negative way, it is recommended in a particularly advantageous embodiment of the coating head that membrane blades projecting above the substrate plane are provided between the individual atomizers. Accordingly, the individual atomizers are delimited from the adjacent atomizers by the membrane blades, as a result of which the respective flow conditions in the region of the atomizers cannot influence each other. In addition, there are defined, mutually delimited areas for the dispensed coating composition particles, so that there is no increased coating composition thickness on the workpiece to be coated, even in the transition area between two atomizers.

The device described can be operated in a method in which the membrane for distributing the coating composition is rotated about an axis of rotation and is subjected to vibration with acoustic waves in the direction of the axis of rotation. Due to the inertia of the coating composition distributed on the membrane, it detaches as finely atomized coating composition particles by changing the vibration direction of the membrane. Since the detachment of the coating composition particles is forced due to the vibration generated by the acoustic waves in the membrane and not by the centrifugal force, as is the case with rotary atomizers, for example, the angular velocities of the membrane can be selected to be low. Accordingly, only a distribution of the coating composition on the membrane, but not a centrifugal force-induced loosening of the coating composition, must be ensured. For example, angular velocities between 90% and 400% of the critical angular velocity ω_{cr} are sufficient, wherein g is the field strength of the gravitational field on the earth's surface and R is the radius of the membrane:

$$\\ {ω}_{cr} = \sqrt{\frac{g}{R}}$$

For a membrane with a diameter of about 2.5 cm, this results in membrane speeds of less than 1000 rpm, whereas conventional rotary atomizers require speeds of between 10000 and 30000 rpm. Due to the low rotational speeds, the method of operating the device according to the invention is much more energy-efficient.

In order to create coating conditions that are both as resource-efficient as possible and as uniform as possible, a vacuum can be applied to the suction channel between the turning point following a first vibration maximum and the next vibration maximum of the acoustic waves. The application of a vacuum causes the turbulence prevailing in the detachment area above the membrane to be rectified, thus preventing the changes in flow direction of the detached coating composition particles caused by the turbulence. In order to suck in as few coating composition particles as possible that have already been detached from the membrane, the suction channel is not permanently subjected to vacuum, but only at a certain time interval, namely when as few coating composition particles of low kinetic energy as possible are in the immediate vicinity of the suction membrane section. The time interval suitable for this lies between the turning point following a first vibration maximum and the next vibration maximum of the acoustic waves. Preferably, the vacuum application can take place in a time interval that lies in the range of the vibration maximum of the acoustic waves. The application of vacuum is preferably repeated in each vibration period, with the detachment of coating composition particles from the membrane and the application of vacuum to the suction channel alternating.

In order to avoid clogging of the feed line of the atomizer when using fast-curing multicomponent coating compositions, it is proposed that at least two components of the coating composition are introduced separately into a coating composition supply line and mixed in the coating composition supply line and/or on the membrane. For example, a coating can be introduced into the coating composition supply line via a first feed line and a hardener for this coating can be introduced into the coating composition supply line via a second feed line.

### BRIEF DESCRIPTION OF THE INVENTION

In the drawing, the subject matter of the invention is shown by way of example, wherein:

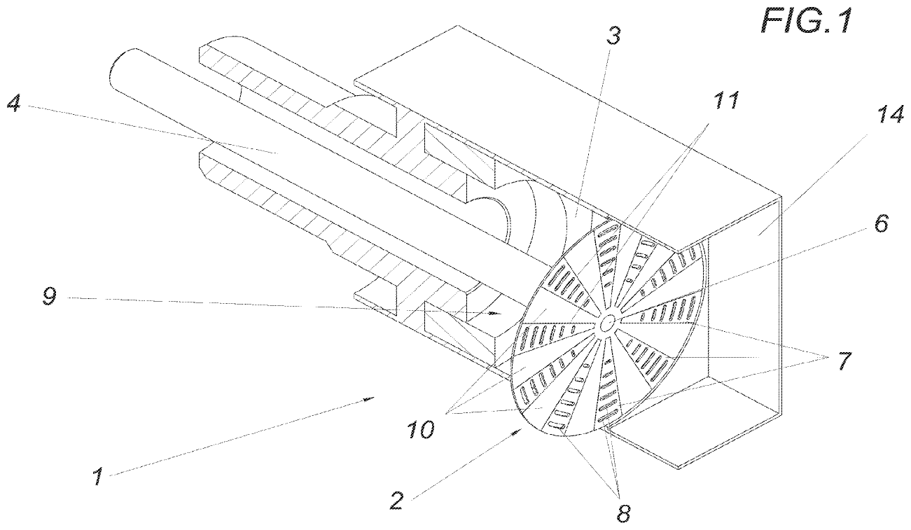

FIG. 1 shows partially sectional perspective view of an atomizer according to the invention,

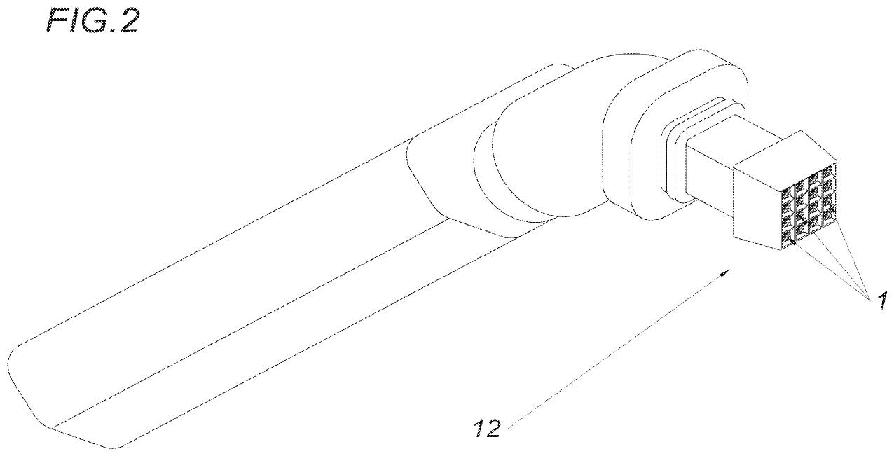

FIG. 2 shows a coating head with several atomizers on a smaller scale,

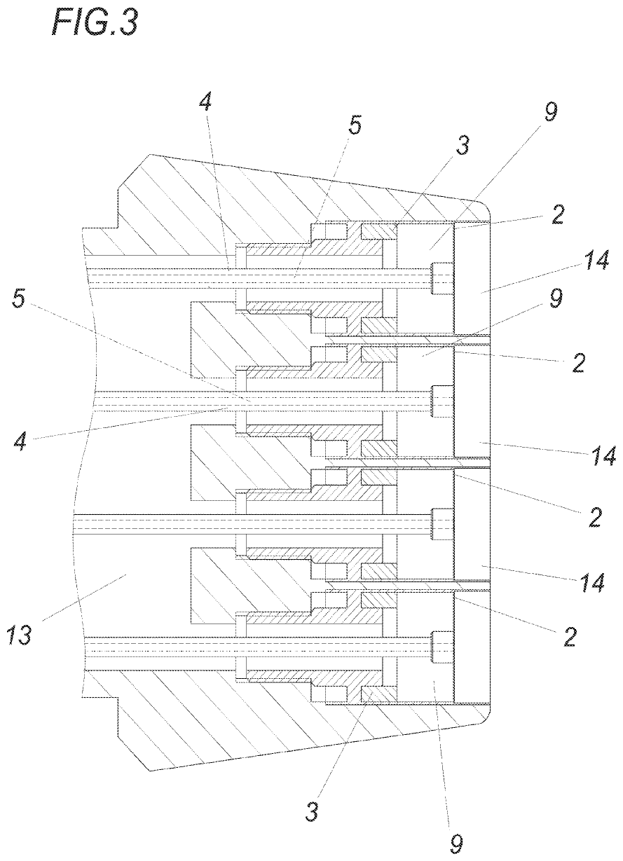

FIG. 3 shows a schematic section through a coating head of FIG. 2 on a larger scale,

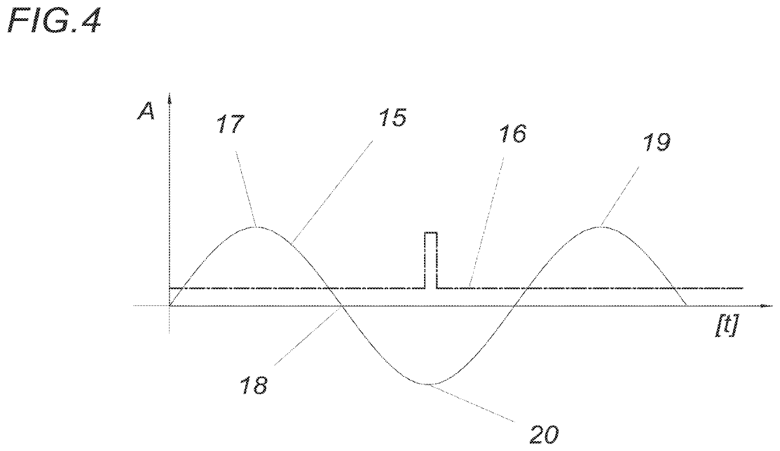

FIG. 4 shows a diagram with a schematic vibration curve of the acoustic wave generated by the exciter and with a control signal for a switching valve, and

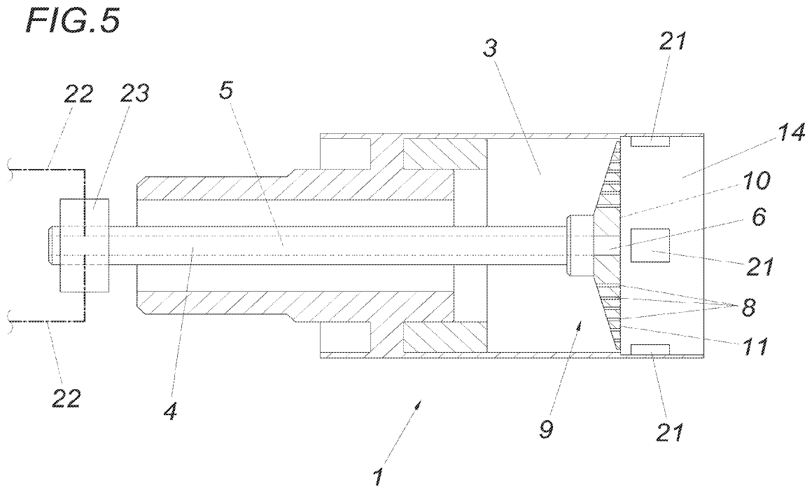

FIG. 5 shows a schematic section through a second embodiment of the atomizer.

### DETAILED DESCRIPTION OF THE PREFERRED EMBODIMENTS

An atomizer 1 according to the invention for a coating composition, for example liquid paint, has a membrane 2 as coating composition substrate, as can be seen in FIG. 1. In this context, the membrane 2 can be subjected to vibrations by an exciter 3 by means of acoustic waves, as a result of which the coating composition located on the coating composition detaches from the membrane 2. In order to enable a uniform distribution of the coating composition on the membrane 2 and thus a homogeneous coating of a workpiece to be coated, the membrane 2 is connected to a rotary drive. The rotation of the membrane 2 thus serves to distribute the coating composition and not to detach the coating composition particles from the membrane 2, which is why low rotational speeds can be used and thus enable energy-saving operation.

The membrane 2 may be connected to the rotary drive via a shaft 4, with a coating composition supply line 5 (FIG. 3) extending through the shaft 4, the orifice opening 6 of which penetrates the membrane 2.

As shown in FIGS. 1 and 3, the membrane 2 can comprise a suction membrane section 7 which is pierced by suction openings 8 and closes off a suction channel 9. The suction channel 9 may be connected to a vacuum reservoir, not shown in more detail, via a switchable valve known to those skilled in the art. The pulsed application of the vacuum results in a rectification of the air flow in the detachment area of the membrane 2 and thus in a dissolution of the turbulence prevailing there, whereby undesirable changes in flow direction of the detached coating composition particles can be reduced.

In order to prevent the coating composition distributed on the membrane 2 from flowing into the suction openings 8, a step 11 (FIG. 1) is provided between the suction membrane section 7 and the remaining membrane surface 10, which retains the coating composition emerging from the orifice opening 6 and thus provides it with a flow path.

In a particularly compact embodiment of the device according to the invention, the shaft 4 can run through the suction channel 9 and concentrically through the exciter 3.

FIG. 2 shows a coating head 12 with a plurality of atomizers 1, these being arranged next to one another in a matrix. The atomizers 1 are arranged in such a way that their membranes 2 lie in a common substrate plane, as disclosed in FIG. 3. The suction channels 9 of the respective atomizers 1 can converge in a common orifice channel 13.

The individual adjacent atomizers 1 can be delimited from one another by membrane blades 14, which project above the substrate plane of the membranes 2. This results in defined, mutually demarcated areas for the dispensed coating composition particles, whereby mutual interference of the flow conditions can be prevented.

FIG. 4 shows schematically the amplitude A of the vibration 15 of the acoustic waves generated by the exciter 3 and thus the vibration 15 of the membrane 2 plotted over time. Furthermore, the control signal 16 for opening a switching valve for applying a vacuum to the exhaust channel 9 is shown. In order to draw as few coating composition particles as possible into the suction channel 9, the suction channel 9 is acted upon by controlling and thus opening and closing the switching valve in time between the turning point 18 following a first vibration maximum 17 and the next vibration maximum 19 of the acoustic waves. Preferably, the vacuum can be applied in a time interval that lies in the range of the vibration minimum 20 of the acoustic waves.

FIG. 5 shows a further embodiment of the atomizer according to the invention. According to this embodiment, the coating composition supply line 5 can be connected to two feed lines 22, for example via a rotary union 23. In this way, different components of multi-component coating composition can be introduced separately into the coating composition supply line 5 and mixed first in the coating composition supply line 5 and then on the membrane 2.

One or more vibration sensors 21 can be assigned to the membrane 2 for monitoring.

The vibration sensors 21 can be arranged on the membrane blades 14 for this purpose.

The membrane 2 of the embodiment shown in FIG. 5 has a conical cross-section, which increases the durability of the membrane 2.

1. An atomizer for a coating composition, said atomizer comprising:
a coating composition substrate that is vibration-excited by an exciter;
wherein the coating composition substrate is a membrane driven by a rotary drive and supplied with acoustic waves by the exciter so as to vibrate.

2. The atomizer according to claim 1, wherein the membrane is pierced by an orifice opening of a coating composition supply line that passes through a shaft connecting the membrane to the rotary drive.

3. The atomizer according to claim 1, wherein the membrane closes off a suction channel with a suction membrane section pierced by suction openings.

4. The atomizer according to claim 3, wherein a step is supported between the suction membrane section and a remaining surface of the membrane retaining the coating composition emerging from the orifice opening.

5. The atomizer according to claim 3, wherein the shaft passes through the suction channel.

6. The atomizer according to claim 2, wherein the shaft extends concentrically through the exciter.

7. The atomizer according to claim 2, wherein the coating composition supply line is connected to at least two feed lines.

8. The atomizer according to claim 1, wherein a vibration sensor detects a frequency and/or amplitude of the membrane.

9. The atomizer according to claim 1, wherein the membrane has a thickness that decreases radially outwards.

10. A coating head comprising a plurality of atomizers according to claim 1, wherein the atomizers are arranged next to one another in a matrix form, and wherein the membranes lie in a common substrate plane.

11. The coating head according to claim 10, wherein membrane blades projecting above the substrate plane are supported between the individual atomizers.

12. A method for operating an atomizer according to claim 1, said method comprising
rotating the membrane about an axis of rotation so as to distribute the coating composition; and
subjecting the membrane to vibration with acoustic waves in a direction of the axis of rotation.

13. The method according to claim 12, wherein the method further comprises, between a turning point following a first vibration maximum and a next vibration maximum of the acoustic waves, subjecting the suction channel to a vacuum.

14. The method according to claim 12, wherein the method further comprises introducing at least two components of the coating composition separately into a coating composition supply line and mixing the components in the coating composition supply line and/or on the membrane.

15. The atomizer according to claim 2, wherein the membrane closes off a suction channel with a suction membrane section pierced by suction openings.

16. The atomizer according to claim 15, wherein a step is supported between the suction membrane section-and a remaining surface of the membrane retaining the coating composition emerging from the orifice opening.

17. The atomizer according to claim 15, wherein the shaft passes through the suction channel.

18. The atomizer according to claim 16, wherein the shaft passes through the suction channel.

19. The atomizer according to claim 15, wherein the shaft extends concentrically through the exciter.
